(19) United States
(12) Patent Application Publication
(10) Pub. No.: US 2017/0105363 A1
(43) Pub. Date: Apr. 20, 2017

(54) SOLAR LIGHT TYPE GLASS GREENHOUSE

(71) Applicant: Asahi Glass Company, Limited, Chiyoda-ku (JP)

(72) Inventors: Naruaki TOMITA, Chiyoda-ku (JP); Takehiro KOSE, Chiyoda-ku (JP); Katsuyoshi NAKAYAMA, Chiyoda-ku (JP); Shigetoshi MORI, Chiyoda-ku (JP); Meiwen CHANG, Chiyoda-ku (JP); Toshihiko HAYASHI, Chiyoda-ku (JP)

(73) Assignee: Asahi Glass Company, Limited, Chiyoda-ku (JP)

(21) Appl. No.: 15/390,107

(22) Filed: Dec. 23, 2016

Related U.S. Application Data
(63) Continuation of application No. PCT/JP2015/069349, filed on Jul. 3, 2015.

(30) Foreign Application Priority Data
Jul. 8, 2014 (JP) 2014-140933

(51) Int. Cl. A01G 9/24; E04H 5/08; E04H 1/00

(52) U.S. Cl. CPC A01G 9/243; A01G 9/24; A01G 9/241; E04H 1/005; E04H 5/08

(57) ABSTRACT

A solar light type glass greenhouse includes a greenhouse unit. The greenhouse unit includes an under-eaves part including north, south, east and west lowersurface parts; and a ceiling part including a sloping roof on a north side, and south, east and west uppersurface parts. The sloping roof slopes by a sloping angle α so that a south side is inclined upward when viewed from east. The sloping angle α satisfies relations 15°<α<67°, and 63.6°-LAT≦α≦69.6°-LAT, where LAT is a latitude of an installation place. The sloping roof includes an eave extending to south beyond the south uppersurface part. A length of the eave is H_{S}×sin(90°-θ_{S})/sin(θ_{S}-α) or more, where θ_{S} is a culmination altitude of the sun in the summer solstice, and H_{S} is a sum of vertical lengths of the south lowersurface part and the south uppersurface part. The sloping roof includes a glass member having a heat reflective function.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2015/069349 filed on Jul. 3, 2015 and designating the U.S., which claims priority of Japanese Patent Application No. 2014-140933 filed on Jul. 8, 2014. The entire contents of the foregoing applications are incorporated herein by reference.

### BACKGROUND OF THE INVENTION

1. Field of the Invention

The present disclosure relates to a solar light type glass greenhouse.

2. Description of the Related Art

Recently, in many countries glass greenhouses using solar light have attracted attention as medium-scale or large-scale horticultural facilities.

Especially, a glass greenhouse referred to as “Venlo-type” developed in Netherlands, has a structure in which skylight windows are arranged in alternating directions in each block, and thereby has a feature of a relatively great amount of incident light (for example, see European Patent Application Publication No. 343287).

### SUMMARY OF THE INVENTION

It is a general object of at least one embodiment of the present invention to provide a solar light type glass greenhouse that substantially obviates one or more problems caused by the limitations and disadvantages of the related art.

According to an aspect of the present invention, there is provided a solar light type glass greenhouse, including a greenhouse unit that includes an under-eaves part and a ceiling part. The under-eaves part includes a north lowersurface part, a south lowersurface part, an east lowersurface part, and a west lowersurface part. The ceiling part includes a sloping roof on a north side, a south uppersurface part on a south side, an east uppersurface part on an east side, and a west uppersurface part on a west side. The north side includes the north lowersurface part and the sloping roof, the south side includes the south lowersurface part and the south uppersurface part, the east side includes the east lowersurface part and the east uppersurface part, the west part includes the west lowersurface part and the west uppersurface part, and a sum of a vertical length of the south lowersurface part and a vertical length of the south uppersurface part is Hs. The sloping roof slopes by a sloping angle α so that a south side of the sloping roof is inclined upward from a horizontal plane when the solar light type glass greenhouse is viewed from east, α being greater than 15° but less than 67°. The sloping angle α satisfies a relation

63.6°-LAT≦α≦69.6°-LAT formula (1)

where LAT is a latitude of an installation place at which the solar light type glass greenhouse is installed. The sloping roof includes an eave having a length L_{E} extending to south beyond the south uppersurface part. The length L_{E} of the eave satisfies a relation

L_{E}≧H_{S}×sin(90°-θ_{S})/sin(θ_{S}-α) formula (2)

where θ_{S} is a culmination altitude of the sun in the summer solstice at the installation place. The south uppersurface part and the south lowersurface part include a glass member. The sloping roof includes a glass member having a heat reflective function.

According to another aspect of the present invention, there is provided a solar light type glass greenhouse including a plurality of greenhouse units, which are arranged adjoiningly in a north-south direction, n being a number of the greenhouse units. Each of the greenhouse units includes an under-eaves part and a ceiling part, the ceiling part including a sloping roof on a north side and a south uppersurface part on a south side. A vertical length of the south uppersurface part is H_{S1}. The sloping roof of each of the greenhouse units slopes by a sloping angle α so that a south side of the sloping roof is inclined upward from a horizontal plane when the solar light type glass greenhouse is viewed from east, α being greater than 15° but less than 67°. The sloping angle α satisfies a relation

63.6°-LAT≦α≦69.6°-LAT formula (1)

where LAT is a latitude of an installation place at which the solar light type glass greenhouse is installed. A southernmost greenhouse unit includes a south lowersurface part on the south side of the under-eaves part. A vertical length of the south lowersurface part is H_{S2}. The sloping roof of the southernmost greenhouse unit includes an eave having a length L_{E} extending to south beyond the south uppersurface part. The length L_{E} of the eave of the southernmost greenhouse unit satisfies a relation

L_{E}≧H_{S}×sin(90°-θ_{S})/sin(θ_{S}-α) formula (2)

where θ_{S} is a culmination altitude of the sun in the summer solstice at the installation place, and H_{S} is a sum of the vertical length H_{S1} of the south uppersurface part of the southernmost greenhouse unit and the vertical length H_{S2} of the south lowersurface part. The sloping roofs of the greenhouse units other than the southernmost greenhouse unit include eaves having a length L_{I} extending to south beyond the south uppersurface parts, respectively. The length L_{I} of the eave satisfies a relation

L_{I}≧H_{S1}×sin(90°-θ_{S})/sin(θ_{S}-α). formula (3)

The south uppersurface part of each of the greenhouse units includes a glass member. The south lowersurface part of the southernmost greenhouse unit includes a glass member. The sloping roof of each of the greenhouse units includes a glass member having a light reflective function.

### BRIEF DESCRIPTION OF THE DRAWINGS

Other objects and further features of embodiments will become apparent from the following detailed description when read in conjunction with the accompanying drawings, in which:

FIG. 1 is a diagram schematically illustrating a configuration of a solar light type glass greenhouse according to a related art;

FIG. 2 is a diagram schematically illustrating a lateral face from a direction of east of a solar light type glass greenhouse according to an embodiment;

FIG. 3 is a diagram schematically illustrating a lateral face from a direction of north of the solar light type glass greenhouse according to the embodiment;

FIG. 4 is a diagram schematically illustrating a relation between a first glass greenhouse and an incident direction of solar light when the sun is at the culmination altitude in the winter solstice season;

FIG. 5 is a diagram schematically illustrating a relation between the first glass greenhouse and an incident direction of solar light when the sun is at the culmination altitude in the summer solstice season;

FIG. 6 is a diagram schematically illustrating a lateral face from a direction of east of another solar light type glass greenhouse according to the embodiment;

FIG. 7 is a graph illustrating a time change of average amount of solar radiation in February according to a first example;

FIG. 8 is a graph illustrating a time change of average amount of solar radiation in August according to the first example;

FIG. 9 is a graph illustrating a time change of average amount of solar radiation in February according to a first comparative example along with the case of the first example;

FIG. 10 is a graph illustrating a time change of average amount of solar radiation in August according to the first comparative example along with the case of the first example;

FIG. 11 is a graph illustrating a time change of average amount of solar radiation in February according to a second comparative example along with the case of the first example; and

FIG. 12 is a graph illustrating a time change of average amount of solar radiation in August according to the second comparative example along with the case of the first example.

### DESCRIPTION OF THE PREFERRED EMBODIMENTS

In the following, referring to the accompanying drawings, an embodiment of the present invention will be described.

(Conventional Solar Light Type Glass Greenhouse)

First, in order to better understand the feature end effect of the present invention, with reference to the drawings, a configuration of a conventional solar light type glass greenhouse (Venlo-type glass greenhouse) will be briefly explained.

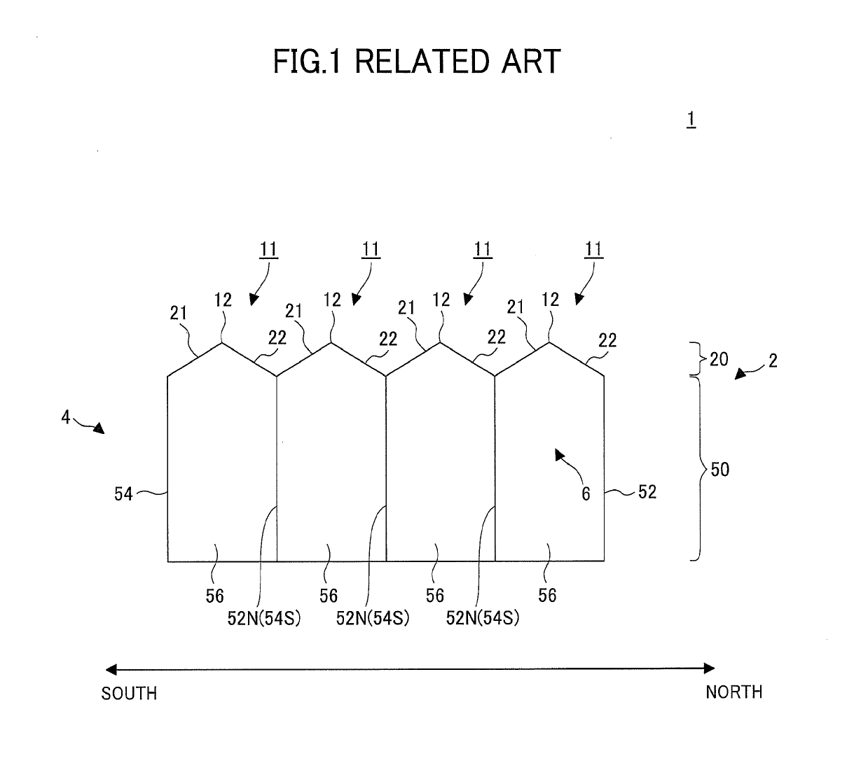

FIG. 1 schematically illustrates a configuration of the Venlo-type glass greenhouse, which has been proposed conventionally. In FIG. 1, the Venlo-type glass greenhouse has a depth direction which is arranged in an east-west direction. FIG. 1 is illustrated as a side view viewed from the east direction.

As illustrated in FIG. 1, the Venlo-type glass greenhouse 1 has a north side 2, a south side 4, an east side 6, and a west side 8 (in FIG. 1, because the west side 8 corresponds to an opposite side, the west side 8 is not illustrated).

The Venlo-type glass greenhouse 1 is formed by arranging a plurality of greenhouse units 11 that are base units along the north-south direction. For example, in FIG. 1, the Venlo-type glass greenhouse 1 is configured by connecting four greenhouse units 11 along the north-south direction.

Each greenhouse unit 11 has a ceiling part 20 including a top portion 12 and an under-eaves part 50.

The ceiling part 20 has roofs 21, 22 arranged north-south symmetrically with respect to a vertical line hung from the top portion 12 of the greenhouse unit 11. The respective roofs 21, 22 are formed with glass members supported by frame members, which are not shown in FIG. 1.

On the other hand, the under-eaves part 50 of each greenhouse unit 11 is configured with respective faces of a north lowersurface part 52, a south lowersurface part 54, an east lowersurface part 56 and a west lowersurface part 58. However, in greenhouse units 11 adjacent to each other, on a north lowersurface part 52N of the greenhouse unit 11 that resides on the south side and on a south lowersurface part 54S of the greenhouse unit 11 that resides on the north side, a wall surface is not present normally, and a one room configuration is often provided by combining the respective units.

The north lowersurface part 52, the south lowersurface part 54, the east lowersurface part 56 and the west lowersurface part 58 configuring the under-eaves part 50 of each greenhouse unit 11 are formed with glass members supported by frame members.

In the Venlo-type glass greenhouse 1, for each greenhouse unit 11, the roofs 21, 22 are arranged in alternating north-south directions. Therefore, in the Venlo-type glass greenhouse 1, an amount of incident light can be made relatively great.

However, with such a Venlo-type glass greenhouse 1, there is a problem that the glass greenhouse 1 is hard to be used effectively throughout the year.

For example, when the Vento-type glass greenhouse 1 is used in a hot season such as a summer season, solar light with an amount of light more than necessary enters inside the greenhouse, and it tends to become higher temperature than a tolerance level inside the greenhouse. Then, in the hot season, the Venlo-type glass greenhouse 1 is hard to be utilized for cultivation of plants or the like. Moreover, when the temperature in the greenhouse is maintained within a predetermined range by using a temperature controller or the like, operational cost may increase markedly.

In addition, in order to avoid such a problem, a glass member having a heat reflective function is considered to be used on the roofs 21, 22 of each greenhouse unit 11. In this case, in the hot season, infrared rays, via the ceiling part 20, can be prevented from entering inside the greenhouse. Therefore, a rise in temperature inside the greenhouse in the hot season can be suppressed to some extent.

However, with such a measure, inversely, in the cold season, since it is hard for infrared radiation to enter inside the greenhouse, there may occur a problem that the temperature inside the greenhouse is less than the predetermined range. As a result, this time, the Venlo type glass greenhouse 1 is hard to be used in the cold season. Moreover, also in this case, when the temperature in the greenhouse is maintained within a predetermined range by using a temperature controller or the like, operational cost may increase markedly.

In this way, in the conventional Venlo-type glass greenhouse 1, there is a problem that the amount of incident solar light for each season fluctuates wildly, and the glass greenhouse 1 is hard to be used effectively throughout the year.

For such a problem, the present invention provides a solar light type glass greenhouse, including a greenhouse unit that includes an under-eaves part and a ceiling part. The under-eaves part includes a north lowersurface part on a north side, a south lowersurface part on a south side, an east lowersurface part on an east side, and a west lowersurface part on a west side. The ceiling part includes a sloping roof on the north side, a south uppersurface part on the south side, an east uppersurface part on the east side, and a west uppersurface part on the west side. The sloping roof slopes by a sloping angle α so that a south side of the sloping roof is inclined upward from a horizontal plane when the solar light type glass greenhouse is viewed from east, α being greater than 15° but less than 67°. The sloping angle α satisfies a relation

63.6°-LAT≦α≦69.6°-LAT formula (1)

where LAT is a latitude of an installation place at which the solar light type glass greenhouse is installed. The sloping roof includes an eave having a length L_{E} extending to south beyond the south uppersurface part. The length L_{E} of the eave satisfies a relation

L_{E}≧H_{S}×sin(90°-θ_{S})/sin(θ_{S}-α) formula (2)

where θ_{S} is a culmination altitude of the sun in the summer solstice at the installation place, and H_{S} is a sum of a vertical length of the south lowersurface part and a vertical length of the south uppersurface part. At least one of the south uppersurface part and the south lowersurface part includes a glass member. The sloping roof includes a glass member having a heat reflective function.

In the solar light type glass greenhouse according to the present invention, a sloping roof is arranged on a portion facing a north side of the ceiling part 20. Moreover, this sloping roof has a feature of having an eave extending toward south, and arranging a glass member with a heat reflective function on the sloping roof.

Moreover, there is a feature that the sloping roof slopes with a predetermined sloping angle α, which is expressed by above-described formula (1), with respect to the horizontal direction.

Furthermore, there is a feature that a length of eave L_{E} of the sloping roof is selected so as to satisfy above-described formula (2).

In the solar light type glass greenhouse having such features, as will be described later in detail, in the hot season, the incident amount of solar light can be suppressed significantly by the glass member having the heat reflective function of the sloping roof, and inversely, in the cold season, the incident amount of solar light can be enhanced significantly by the glass members of the south uppersurface part and the south lowersurface part directed to south.

Therefore, in the solar light type glass greenhouse according to the embodiment, an amount of incident light entering the greenhouse can be maintained within a predetermined range throughout the year. Moreover, according to the embodiment, a solar light type glass greenhouse that can be utilized throughout the year while suppressing the operation cost can be provided.

(Solar Light Type Glass Greenhouse According to an Embodiment of Present Invention)

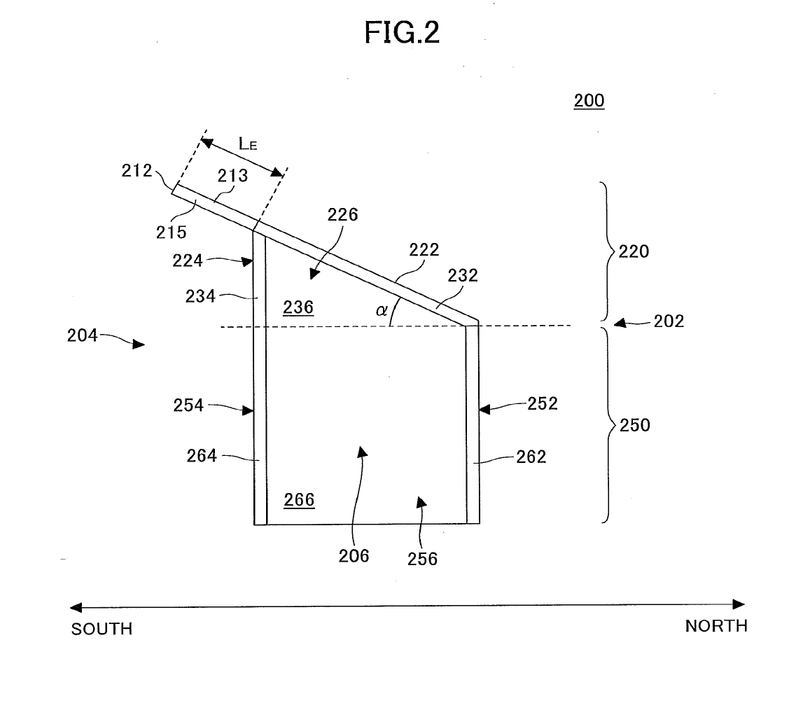

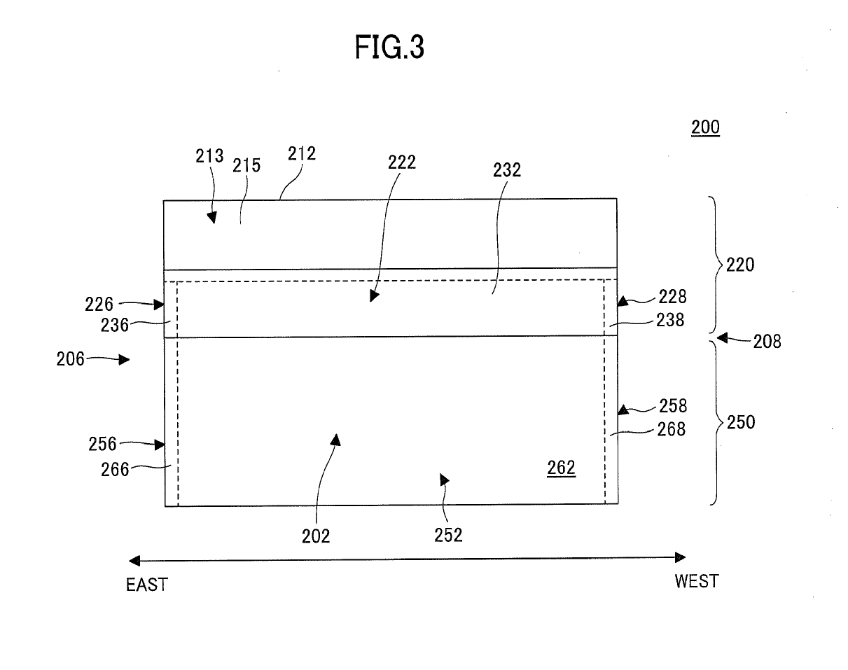

Next, with reference to FIGS. 2 and 3, a solar light type glass greenhouse according to an example of the present invention will be described.

FIG. 2 and FIG. 3 schematically illustrate a configuration of the solar light type glass greenhouse according to the example of the present invention (referred to as a “first glass greenhouse”). FIG. 2 illustrates a lateral face when the first glass greenhouse is viewed from the east direction. FIG. 3 illustrates a lateral face when the first glass greenhouse is viewed from the north direction.

Here, in the present application, it is necessary to pay attention that respective directions expressed by east, west, south and north (four orientations) are not directions in a strict sense used in such as surveying or aspect divination, but any orientation is a concept tolerating deviation of a range of about ±45° (eight orientations).

As illustrated in FIG. 2 and FIG. 3, the first glass greenhouse 200 is provided with a north side 202, a south side 204, an east side 206 and a west side 208.

Moreover, the first glass greenhouse 200 has a ceiling part 220 and an under-eaves part 250. The ceiling part 220 has a sloping roof 222 having an eave 213.

Here, the ceiling part 220 is assumed to represent a height region from a lowermost part of the sloping roof 222 to an outer end 212 in the first glass greenhouse 200, and the under-eaves part 250 is assumed to represent a height region lower than the ceiling part 220 in the first glass greenhouse 200.

As illustrated in FIG. 2 and FIG. 3, the ceiling part 220 includes a south uppersurface part 224 arranged on the south side 204, an east uppersurface part 226 arranged on the east side 206, and a west uppersurface part 228 arranged on the west side 208. In addition, a sloping roof 222 is arranged on the north side 202 of the ceiling part 220.

On the other hand, the under-eaves part 250 includes four faces of a north lowersurface part 252, a south lowersurface part 254, an east lowersurface part 256 and a west lowersurface part 258.

The sloping roof 222 forms the north side 202 of the first glass greenhouse 200 along with the north lowersurface part 252. Similarly, the south uppersurface part 224 forms the south side 204 of the first glass greenhouse 200 along with the south lowersurface part 254. The east uppersurface part 226 forms the east side 206 of the first glass greenhouse 200 along with the east lowersurface part 256. Moreover, the west uppersurface part 228 forms the west side 208 of the first glass greenhouse 200 along with the west lowersurface part 258.

Here, except for the north side 202 of the first glass greenhouse 200, on each of the sides 204, 206, and 208, the uppersurface part and the lowersurface part thereof are continuously arranged vertically, and thereby on each side of the glass greenhouse unit 100 a vertical wall is formed.

The sloping roof 222 has an eave 213 at a south most end. Therefore, an outer end 212 of the eave 213 becomes the outer end 212 of the sloping roof 222.

In the embodiment, the eave 213 is assumed to represent a part on the south side of the south uppersurface part 224 in the sloping roof 222 (See length L_{E} in FIG. 2).

The sloping roof 222 of the ceiling part 220 is formed of a glass member, a frame member and the like. The eave 213 is formed of an eave member that shields or attenuates transmission of solar light, or attenuates a transmission of infrared light.

Each of the uppersurface parts 224, 226, 228 of the ceiling part 220 is formed of a glass member, a frame member and the like. Similarly, each of the lowersurface parts 252, 254, 256 and 258 of the under-eaves part 250 is formed of a glass member, a frame member and the like.

However, in FIG. 2 and FIG. 3, the frame members are not illustrated in order to be easily understood. That is, in FIG. 2 and FIG. 3, only glass members are illustrated in the respective uppersurface parts 224, 226, 228 on the north side. Similarly, in the respective lowersurface parts 252, 254, 256, 258, only glass members are illustrated. On the other hand, in the sloping roof 222, both an eave member and a glass member are illustrated.

More specifically, in FIG. 2 and FIG. 3, the sloping roof 222 is formed by a first ceiling glass member 232 and an eave member 215, the south uppersurface part 224 is formed by a second ceiling glass member 234, the east uppersurface part 226 is formed by a third ceiling glass member 236, and the west uppersurface part 228 is formed by a fourth ceiling glass member 238. Similarly, the north lowersurface part 252 is formed by a first under-eaves glass member 262, the south lowersurface part 254 is formed by a second under-eaves glass member 264, the east lowersurface part 256 is formed by a third under-eaves glass member 266, and the west lowersurface part 258 is formed by a fourth under-eaves glass member 268.

However, the above-described configuration is merely an example. For example, the east uppersurface part 226 and the east lowersurface part 256 forming the east side 206, and the west uppersurface part 228 and the east lowersurface part 258 forming the west side 208 do not necessarily include glass members.

In the present application, it is necessary to pay attention that the expressions “uppersurface part” and “lowersurface part” which are matters of expediency for clarifying the explanation. For example, the uppersurface part and the lowersurface part may be formed as an integrated member.

Here, in the first glass greenhouse 200, the first ceiling glass member 232 arranged on the sloping roof 222 has a heat reflective function. For example, the first ceiling glass member may be a Low-E glass.

Moreover, in the first glass greenhouse 200, the sloping roof 222 is arranged in a state of sloping with a sloping angle α so that the south side is in an upward direction (inclined upward) with respect to the horizontal plane, viewed from the orientation of east.

The sloping angle α is defined based on the culmination altitude of the sun in the winter solstice, i.e. at a time when daytime is the shortest throughout the year, at a place where the first glass greenhouse 200 is installed. Here, the term “culmination altitude” means an angle between the sun and horizon at the time when the sun rises the highest in a day.

More specifically, the sloping angle α is selected so as to satisfy the formula

θ_{W}-3°≦α≦θ_{W}+3° formula (4)

where θ_{W}(°) is the culmination altitude of the sun in the winter solstice. Here, the culmination altitude θ_{W}(°) in the winter solstice is expressed by the formula

θ_{W}=90°-LAT-23.4° formula (5)

where LAT is the latitude (north latitude, south latitude) of the place where the first glass greenhouse 200 is installed. As a result, the sloping angle α becomes

63.6°-LAT≦α≦69.6°-LAT formula (1)

from formula (4) and formula (5).

More preferably, the sloping angle satisfies the formula

θ_{W}-1.5°≦α≦θ_{W}+1.5°. formula (6)

Then, the sloping angle α becomes

65.1°-LAT≦α≦68.1°-LAT. formula (7)

Furthermore, in the first glass greenhouse 200, the length L_{E} of the eave 212 on the sloping roof 222 is defined as follows, based on the culmination altitude of the sun in the summer solstice, i.e. at a time when daytime is the longest throughout the year, at a place where the first glass greenhouse 200 is installed.

That is, when the culmination altitude of the sun in the summer solstice is θ_{S}(°), θ_{S}(°) is expressed by the formula:

θ_{S}=90°-LAT+23.4°. formula (8)

When a sum of a vertical length of the under-eaves part 250 of the south side 204 (i.e. vertical length H_{S2} of the south lowersurface part 254) and a vertical length of the ceiling part 220 of the south side 204 (i.e. vertical length H_{S1} of the south uppersurface part 224) is H_{S}, the length L_{E} of the eave 212 is expressed using the sloping angle α, by the formula

L_{E}≧H_{S}×sin(90°-θ_{S})/sin(θ_{S}-α) formula (2)

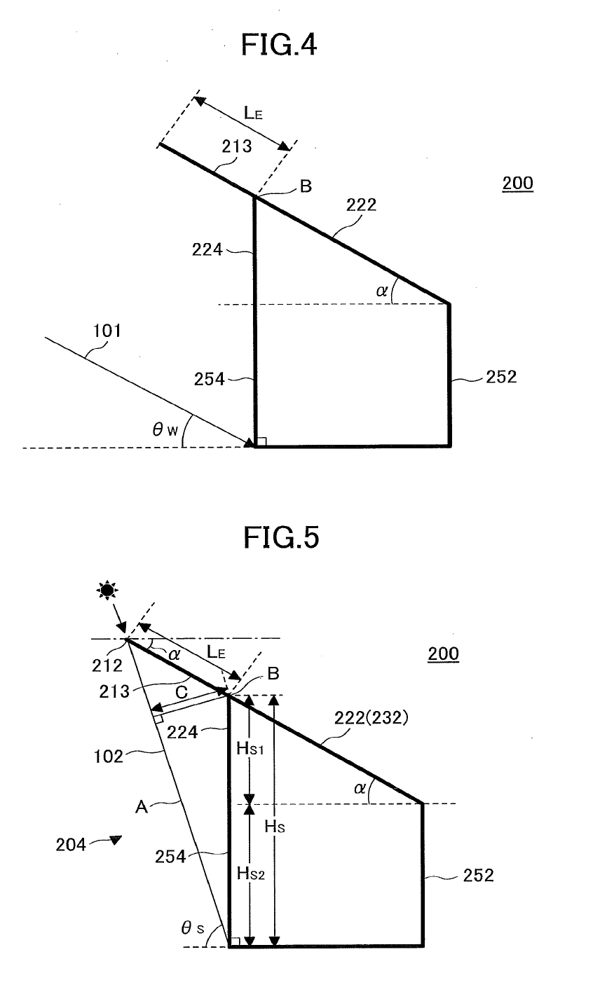

In the following, referring to FIG. 4 and FIG. 5, an effect of the sloping roof 222 having the above-described feature will be described.

FIG. 4 schematically illustrates a lateral face when viewing the first glass greenhouse 200 in a daytime in the winter solstice from the orientation of east. Moreover, FIG. 5 schematically illustrates the lateral face when viewing the first glass greenhouse 200 in a daytime in the summer solstice from the orientation of east.

As illustrated in FIG. 4 and FIG. 5, the sloping roof 222 of the first glass greenhouse 200 has a sloping angle α. Moreover, the sloping roof 222 has an eave with a whole length of L_{E}. As illustrated in FIG. 5, a height of the south side 204 of the first glass greenhouse 200, i.e. a vertical length H_{S} of a wall on a south side is expressed by a sum of a vertical length H_{S1} of the south uppersurface part 224 and a vertical length H_{S2} of the south lowersurface part 254, H_{S}=H_{S1}+H_{S2}.

Here, a case where incident light from the sun enters the first glass greenhouse 200 will be considered.

First, in the winter solstice, when the sun is at the culmination altitude, as illustrated in FIG. 4, an incident direction (θ_{W}) of solar light 101, with which the first glass greenhouse 200 is irradiated, is approximately parallel to the orientation of the sloping roof 222. This is because the sloping angle α of the sloping roof 222 is selected so as to satisfy above-described formula (1).

Therefore, in the cold season including the winter solstice, a great amount of incident light 101 from the sun can be taken via the south uppersurface part 224 and the south lowersurface part 254 on the south side of the first glass greenhouse 200. As a result, a running cost of a temperature controlling (heating) equipment in the first glass greenhouse in the cold season can be significantly suppressed.

On the other hand, in the summer solstice, when the sun is at the culmination altitude, as illustrated in FIG. 5, an incident direction (θ_{S}) of solar light 102 entering the first glass greenhouse 200 is greater than the sloping angle α of the sloping roof 222.

However, in the sloping roof 222, the first ceiling glass member 232 having a heat reflective function is used. Therefore, incidence of solar light 102 via the sloping roof 222 is significantly suppressed.

Moreover, the sloping roof 222 is provided with the eave 213.

Here, in FIG. 5, when a distance from a line segment A (a line parallel to solar light 102 and a line segment connecting an outer end 212 of the eave 213 and a bottom face of the south lowersurface part 254) to the southernmost point B excluding the eave 213 of the sloping roof 222 is c, c is expressed by the formula

c=H_{S}×sin(90°-θ_{S}). formula (9)

Moreover, the length LE of the eave is expressed using c by the formula

L_{E}=c/sin(θ_{S}-α). formula (10)

Therefore, when solar light 102 enters the bottom face of the south lowersurface part 254 of the first glass greenhouse 200, from formula (9) and formula (10), the formula

L_{E}=H_{S}×sin(90°-θ_{S})/sin(θ_{S}−α) formula (11)

is obtained.

As a result, it is found that when the length LE of the eave 213 is greater than or equal to the right hand side of formula (11), i.e. above-described formula (2) is satisfied, solar light 102 no longer enters the south side of the first glass greenhouse 200 (the south uppersurface part 224 and the south lowersurface part 254) according to the shielding effect by the eave 213.

In this way, when the sloping roof 222 is formed of the first ceiling glass member 232 having a heat reflective function and the length LE of the eave 213 is selected so as to satisfy formula (2), incidence of solar light 102 can be significantly suppressed in the hot season including the summer solstice. As a result, a running cost of a temperature controlling (cooling) equipment in the first glass greenhouse in the hot season can be significantly suppressed.

In this way, in the first glass greenhouse 200, in the hot season, an amount of incidence of solar light can be significantly suppressed. Moreover, inversely, in the cold season, the amount of incidence of solar light can be increased significantly.

Therefore, in the first glass greenhouse 200, an amount of light entering the greenhouse can be maintained within a predetermined range throughout the year. Moreover, according to the above configuration, while suppressing an operation cost, the first glass greenhouse 200 can be utilized throughout the year.

(Regarding Respective Members)

Next, the respective members forming the first glass greenhouse 200, as illustrated in FIG. 2 and FIG. 3, in particular, the glass members applied to the respective places will be described in detail. Here, upon indicating the respective members, the reference numerals illustrated in FIG. 2 to FIG. 3 will be used.

(Eave Member 215)

The eave member 215 forming the eave 213 may be formed of any material, as long as transmission of solar light can be shielded or attenuated, or transmission of infrared rays can be attenuated. The eave member 215 may be formed of plate-like or film-like material including metal, resin or cloth. The eave member may be a glass member having a heat reflective function.

Here, the length LE of the eave 213 is preferably less than 2×H_{S}×sin(90°-θ_{S})/sin(θ_{S}-α). Increasing the size of the eave beyond this value causes an increase of weight of the eave part and necessity of reinforcement for a part supporting the eave. Therefore, the great size of the eave is impractical.

The eave may be detachable. In this case, depending on the season (rainy season, typhoon, or the like), the greenhouse can be used without the eave.

(First Ceiling Glass Member 232)

The first ceiling glass member 232 applied to the sloping roof 222 may be any glass member, as long as is has a heat reflective function.

For example, the first ceiling glass member 232 may be formed by arranging a transparent conductive coating having an infrared reflective function on a surface of a glass substrate.

Such transparent conductive coating includes tin oxide, indium oxide, tin-doped indium oxide, zinc-doped indium oxide, zinc oxide, and the like.

A coating method for the transparent conductive coating is not particularly limited. The transparent conductive coating can be formed using a general coating process, such as a pyrolytic method, a PVD method, a CVD method, a sputtering method, a sol-gel method and the like.

A thickness of the transparent conductive coating is not particularly limited. The thickness of the transparent conductive coating may be, for example, within a range of 200 nm to 500 nm.

In addition, on the transparent conductive coating, a further different layer (e.g. a low refractive index layer and/or a protection layer) may be arranged. This layer is not necessarily a coating-like form but may be formed of a thin glass plate, for example.

Alternatively, the first ceiling glass member 232 may be formed of a multilayered glazing. The multilayered glazing is foisted by laminating two glass substrates via an intermediate layer such as dry air.

When a multilayered glazing is applied to the first ceiling glass member 232, in addition to the heat reflective function of the sloping roof 222, heat transfer over inside and outside the greenhouse can be suppressed within a predetermined range. That is, throughout the year, change in temperature of the greenhouse can be even more suppressed.

Such a multilayered glazing may be Low-E glass.

(Second Ceiling Glass Member 234)

The second ceiling glass member 234 applied to the south uppersurface part 224 may be any glass member, capable of transmitting solar light. The second ceiling glass member 234 may be a multilayered glazing. In this case, as described above, heat transfer over inside and outside the greenhouse can be suppressed within a predetermined range.

(First Under-Eaves Glass Member 262)

The first under-eaves glass member 262 applied to the north lowersurface part 252 may be any glass member.

Especially, the first under-eaves glass member 262 preferably has a function of reflecting solar light toward inside of the greenhouse (mirror function). In this case, incident light entering the first glass greenhouse 200 can be maintained inside the greenhouse.

Glass having such a function may be formed, for example, by arranging a reflection coating on a glass substrate.

Such reflection coating is not limited to this, but may be formed, for example, from silver.

A coating method for the reflection coating is not particularly limited. The reflection coating can be formed using a general coating process, such as a pyrolytic method, a PVD method, a CVD method, a sputtering method, a sol-gel method and the like.

A thickness of the reflection coating is not particularly limited. The thickness of the reflection coating may be, for example, within a range of 200 nm to 500 nm.

In addition, the first under-eaves glass member 262 may be a multilayered glazing. In this case, as described above, heat transfer over inside and outside the greenhouse can be suppressed within a predetermined range.

(Second Under-Eaves Glass Member 264)

The second under-eaves glass member 264 applied to the south lowersurface part 254 may be any glass member, capable of transmitting solar light. The second under-eaves glass member 264 may be a multilayered glazing. In this case as described above, heat transfer over inside and outside the greenhouse can be suppressed within a predetermined range.

(Other Glass Members)

Other glass members, i.e. the third and fourth ceiling glass members 236, 238, and the third and fourth under-eaves member 266, 268 may be any glass members.

These glass members may be multilayered glazing. In this case, as described above, heat transfer over inside and outside the greenhouse can be suppressed within a predetermined range.

For the above-described glass members (the first ceiling glass member 232, the second ceiling glass member 234, the first under-eaves glass member 262, the second under-eaves glass member 264, and the other glass members), a material that suppresses transmission of ultraviolet light may be used. In order to suppress transmission of ultraviolet light, a glass material of with composition with low transmittivity of ultraviolet light may be used. Alternatively, the glass member may be coated with a layer having low transmittivity of ultraviolet light. By suppressing transmission of ultraviolet light, degradation of resin members used in the greenhouse, film members, paint and the like can be suppressed. Moreover, by using the material that controls transmission of ultraviolet light, pests are prevented from entering the glass greenhouse or reduced. Furthermore, when bringing out subtle colors by flowering trees and shrubs or fruit trees, the color developments are suppressed.

Moreover, for the above-described glass members (the first ceiling glass member 232, the second ceiling glass member 234, the first under-eaves glass member 262, the second under-eaves member 264, and the other glass members), on surfaces on inner sides of the greenhouse, an antisticking function can be given. The antisticking function can be given by applying antisticking agent, forming coating having antisticking property, arranging film having antisticking property, or the like. When water drops fall locally, illness of crops may be promoted. By giving antisticking property to the wall surface inside the greenhouse, falling of dew drop or the like on crops inside the greenhouse can be suppressed, and thereby the yield can be expected to be prevented from decreasing.

(Regarding Size)

Next, an example of schematic size of the first glass greenhouse 200, as illustrated in FIG. 2 to FIG. 3 will be described. These sizes are merely examples, and it is apparent that respective sizes of the first glass greenhouse may have other sizes.

A height of the first glass greenhouse 200, i.e. a vertical length from the ground to the outer end 212 of the sloping roof 222 is, for example, in a range of 1 m to 10 m, and may be, for example, in a range of 2 m to 6 m.

Moreover, a sum (H_{S}) of the vertical length (H_{S1}) of the south uppersurface part 224 of the first glass greenhouse 200 and the vertical length (H_{S2}) of the south lowersurface part 254 is, for example, in a range of 1 m to 10 mm, and may be, for example, in a range of 2 m to 6 m.

Moreover, the vertical length of the north lowersurface part 252 of the first glass greenhouse 200, i.e. the vertical length of the under-eaves part 250 is, for example, in a range of 0.5 m to 9 m, and may be, for example, in a range of 1.5 m to 3.5 m.

In addition, a width in the north-south direction of the east side 206 (or the west side 208) of the first glass greenhouse 200 is, for example, in a range of 1 m to 6 m, and may be, for example, in a range of 2 m to 5 m.

The sloping angle α of the sloping roof 222 is, as is evident from above-described formula (1), dependent on the latitude LAT of the location where the first glass greenhouse 200 is installed. The sloping angle α is in a range of 15°<α<67°.

This is because, when the sloping angle α is less than or equal to 15°, or greater than or equal to 67°, little incident light is acquired, or inversely, a significant amount of incident light is introduced throughout the year, and the above-described effect is hard to be obtained.

As described above, in the first glass greenhouse 200, the north side 202 is not necessary to be oriented to the “north” (only north direction indicated by a compass or the like) as a bearing in a strict sense (same applies to the other sides). That is, the north side 202 may be deviated from the “north” as a bearing to the side of bearing of west or east by 45 at a maximum.

Especially, it is expected that in a narrow geography such as Japan, for example, a case often occurs where the respective orientations of the solar light type glass greenhouse are hard to be arranged along the bearings of east, west, south and north in a strict sense. It is necessary to pay attention that even in such a case, as long as the north side of the solar light type glass greenhouse is in the above-described range, such solar light type glass greenhouse is included in the scope of the present invention.

In the greenhouse according to the present invention, supplemental lighting may be performed by installing a light irradiation apparatus inside the greenhouse. When an increase of yield is desired or when an amount of sunlight is decreased due to weather variance or the like, by performing the supplemental lighting by the light irradiation apparatus, an amount of light, with which cultivated plants in the greenhouse is irradiated, can be increased. Moreover, when cultivating in high density, shadow areas increase, and the supplemental lighting becomes effective. Upon performing the supplemental lighting, by controlling the carbon dioxide concentration in the greenhouse to be maintained higher, photonic synthesis can be activated effectively. Furthermore, by controlling a wavelength upon performing the supplemental lighting, more efficient irradiation is enabled.

(Another solar light type glass greenhouse according to an embodiment of the present invention)

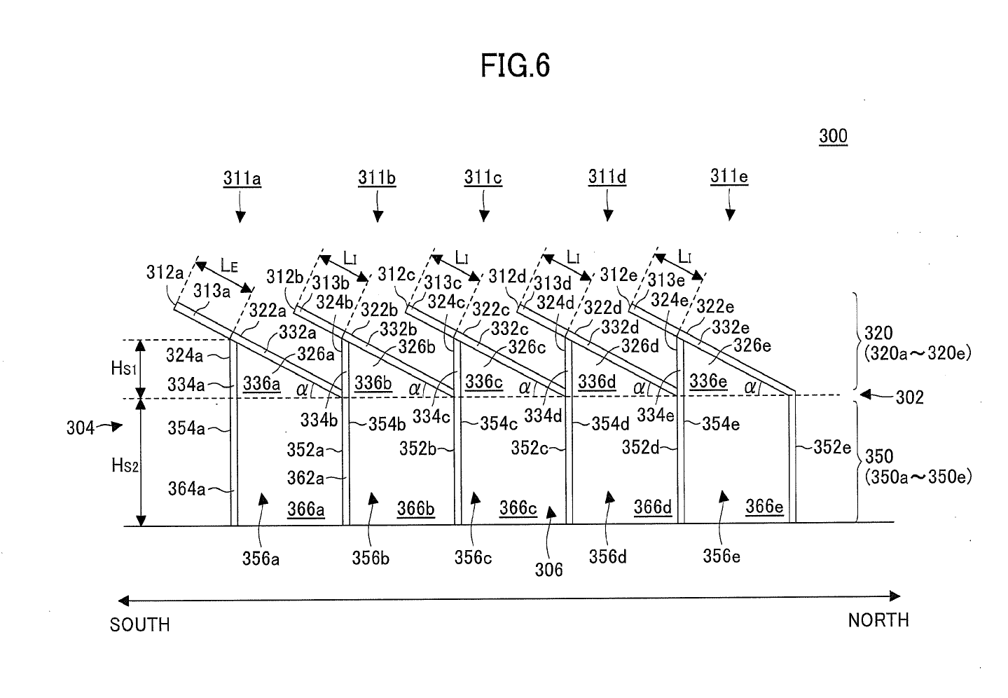

Next, referring to FIG. 6, another solar light type glass greenhouse (second glass greenhouse) according to the embodiment of the present invention will be described.

FIG. 6 schematically illustrates a configuration of the second glass greenhouse 300. In FIG. 6, a lateral face when viewing the second glass greenhouse from the direction of east.

As illustrated in FIG. 6, the second glass greenhouse 300 has a north side 302, a south side 304, an east side 306 and a west side 308 (not visible in FIG. 3). Moreover, the second glass greenhouse 300 has a ceiling part 320 and an under-eaves part.

The second glass greenhouse 300 is configured in a form in which greenhouse units having the same shape are arranged as a plurality of blocks arranged along the north-south direction. For example, in FIG. 3, by arranging five blocks of first to fifth greenhouse units 311a to 311e consecutively, the second glass greenhouse 300 is formed. However, the number of arranged greenhouse units is arbitrary.

Each of the greenhouse units 311a to 311e (in the following, simply referred to as a “greenhouse unit 311”) has the same configuration as the first glass greenhouse 200, illustrated in FIG. 2 which is described above.

For example, the first greenhouse unit 311a arranged at the south end has, as the ceiling part 320a, a sloping roof 322a, a south uppersurface part 324a, an east uppersurface part 326a, and a west uppersurface part 328a (not shown). Moreover, the first greenhouse unit 311a has, as the under-eaves part 350a, a north lowersurface part 352a, a south lowersurface part 354a, an east lowersurface part 356a and a west lowersurface part 358a (not shown).

The sloping roof 322a has an eave 313a on the side of the south end part 312a. Moreover, the sloping roof 322a is arranged in a state of sloping with a sloping angle α so that the south side is in an upward direction (inclined upward) with respect to the horizontal plane, viewed from a bearing of east.

The sloping roof 322a of the first greenhouse unit 311a is formed of a first ceiling glass member 332a. The first ceiling glass member 332a is, for example, formed of glass having a light reflective function, such as Low-E glass. On the other hand, the eave 313a is formed is formed of an eave member that shields or attenuates transmission of solar light, or attenuates a transmission of infrared rays.

As illustrated in FIG. 6, in the first greenhouse unit 311a, the south uppersurface part 324a is formed of a second ceiling glass member 334a, the east uppersurface part 326a is formed of a third ceiling glass member 336a, and the west uppersurface part 328a is formed of a fourth ceiling glass member 338a (not shown).

Moreover, in the under-eaves part 350a of the first greenhouse unit 311a, the north lowersurface part 352a is formed of a first under-eaves glass member 362a, the south lowersurface part 354a is formed of a second under-eaves glass member 364a, the east lowersurface part 356a is formed of a third under-eaves glass member 366a, and the west lowersurface part 358a is formed of a fourth under-eaves glass member 368a (not shown).

However, in a normal case, the respective parts are formed of glass members, frame members and the like, not only of the glass member.

Moreover, the east uppersurface part 326a and the east lowersurface part 356a on the east side 306 of the first greenhouse unit 311a, and the west uppersurface part 328a and the west lowersurface part 358a on the west side 308 do not necessarily have a glass member.

In the second glass greenhouse 300, the sloping roof 322a is arranged in a state of sloping with a sloping angle α so that the south side 304 is in an upward direction (inclined upward) with respect to the horizontal plane, viewed from a bearing of east.

The sloping angle α is in a range of 15°<α<67°, and is selected so as to satisfy the relation

63.6°-LAT≦α≦69.6°-LAT formula (1)

where LAT (°) is the latitude (north latitude, south latitude) of the place where the second glass greenhouse 300 is installed.

The second to fifth greenhouse units 311b to 311e are also configured in almost the same way as the first greenhouse unit 311a.

The ceiling parts 320a to 320e of the respective greenhouse units 311a to 311e form the ceiling part 320 of the second glass greenhouse 300, by combining the whole. Moreover, the under-eaves parts 350a to 350e of the respective greenhouse units 311a to 311e form the under-eaves part 350 of the second glass greenhouse 300, by combining the whole.

In addition, in the greenhouse units 311 adjacent to each other, because the north lowersurface part of the greenhouse unit 311 that resides on the south side and the south lowersurface part of the greenhouse unit 311 that resides on the north side overlap, they are normally omitted, and a one room configuration is provided by combining the respective units. For example, because the north lowersurface part 352a of the first greenhouse 311a overlaps with the south lowersurface part 354b of the second greenhouse unit 311b, one of the north lowersurface part 352a and the south lowersurface part 354b is omitted.

Here, in the second glass greenhouse 300, the first ceiling glass members 332a to 332e arranged in the respective sloping roofs 322a to 322e have a light reflective function.

Moreover, the length L_{E} of the eave 313a of the sloping roof 322a in the first greenhouse unit 311a is different from a length L_{I} of eaves 313b to 313e of the sloping roofs 322b to 322e in the other greenhouse units 311b to 311e.

That is, the length L_{E} of the eave 313a of the sloping roof 322a in the first greenhouse unit 311a is selected so as to satisfy the formula

L_{E}≧H_{S}×sin(90°-θ_{S})/sin(θ_{S}-α) formula (2)

where θ_{S} (°) taken at the culmination altitude of the sun in summer solstice.

On the other hand, the length L_{I} of the eaves 313b to 313e of the sloping roofs 322b to 322e on the other greenhouse units 311b to 311e is selected so as to satisfy the formula

L_{I}≧H_{S1}×sin(90°-θ_{S})/sin(θ_{S}-α). formula (3)

where H_{S1} is a vertical length of the south uppersurface parts 324b to 324e on the ceiling parts 320b to 320e.

When the eave 313a having the above-described length L_{E} and the eaves 313b to 313e having the length L_{I} are arranged, according to a shield effect or an attenuation effect for infrared rays by the eaves 313a to 313e, incidence of solar light in daytime in the summer solstice on the south side (the south uppersurface parts 324a to 323e and the south lowersurface part 354a) of the second glass greenhouse 300 is substantially reduced.

Therefore, in the respective greenhouse units 311a to 311e, when the sloping roof is formed by the glass members 332a to 332e having a heat reflective function, and the lengths L_{E}, L_{I} of the eaves 313a to 313e are selected described as above, in the hot season including the summer solstice, incidence of solar light 102 of daytime can be significantly suppressed. As a result, the operation cost of the temperature controlling (cooling) equimpent in the second glass greenhouse 300 in the hot season can be significantly suppressed.

On the other hand, in the respective greenhouse units 311a to 311e, the sloping angle α of the sloping roofs 322a to 322e is selected so as to satisfy above-described formula (1).

Therefore, in the cold season such as the winter solstice, incident light 101 of daytime from the sun can be taken via the south uppersurface parts 324a to 324e of the respective greenhouse units 311a to 311e and the south lowersurface part 354a of the first greenhouse unit 311a. As a result, the operation cost of the temperature controlling (heating) equipment in the second glass greenhouse 300 in the cold season can be significantly suppressed.

According to the effects, in the second glass greenhouse 300, an amount of light entering the greenhouse can be maintained within a predetermined range throughout the year. Moreover, the second glass greenhouse 300 can be used throughout the year while suppressing the operation cost.

(Regarding Respective Members Forming the Second Glass Greenhouse 300)

Because the respective members forming the second glass greenhouse 300 can be easily derived by analogy from the explanation regarding the respective members forming the first glass greenhouse, redundant explanation will be omitted.

In addition, in the second glass greenhouse 300, the number of arrangement of the greenhouse units 311 is not limited in particular. The number of arrangement of the greenhouse units 311 is, for example, in the range of 2 to 30, and may be, for example, in the range of 2 to 15.

In the respective greenhouse units 311b to 311e except for the first greenhouse unit 311a that is arranged at the southernmost position, the length L_{I} of the eaves 313b to 313e is preferably less than 2×H_{S1}×sin(90°-θ₃)/sin(θ_{S}-α). When the eave has the size greater than or equal to this, a weight of the eave part increases, an eave supporting part needs reinforcement, and such a size is impractical. The eave may be detachable. In this case, depending on the season (rainy season, typhoon, or the like), the greenhouse can be used without the eave.

The “Venlo-type” glass greenhouse has a feature that solar light can be easily introduced in the cold season, but has a problem that in the summer season solar light tends to be made incident more than necessary, and temperature inside the greenhouse easily becomes high. Moreover, in order to deal with such a problem, when trying to maintain the temperature inside the greenhouse within a predetermined range by using a temperature controlling equipment or the like, operational cost may increase markedly.

Therefore, in the “Venlo-type” glass greenhouse, horticultural cultivation is often suspended in the summer season, and it is a situation that a glass greenhouse is said not to be used efficiently throughout the year.

Accordingly, a solar light type glass greenhouse, in which seasonal variation in an amount of incident solar light is hard to occur, and which is usable throughout the year has been desired.

According to the present invention, a solar light type glass greenhouse that can maintain an amount of solar radiation within a predetermined range, stably throughout the year can be provided.

### EXAMPLE

Next, an example of the present invention will be described.

### First Example

Supposing a glass greenhouse according to the first example of the present invention, an amount of solar radiation entering the glass greenhouse throughout the year is calculated.

Here, as a configuration of the glass greenhouse, the second glass greenhouse 300, as illustrated in above-described FIG. 6, is employed. That is, the glass greenhouse used for calculation is assumed to be formed by connecting five blocks of greenhouse units having the same shape. In the following description, for the clarification, upon explaining each member, reference numerals obtained by omitting symbol part of a to e of the reference numerals used in FIG. 6, will be used.

In each greenhouse unit 311, a width in the south-north direction is assumed to be 3 m, a width in the east-west direction is assumed to be 10 m. Moreover, in each greenhouse unit 311, the vertical length H_{S1} of the south uppersurface part 324 is assumed to be 1.5 m, and the vertical length H_{S2} of the south lowersurface part 354 (equal to the vertical length of the north lowersurface part 352) is assumed to be 2.5 m. Therefore, in each greenhouse unit 311, the vertical length of the wall on the south side is H_{S}-4 m.

The sloping angle α of the sloping roof 322 is 30.1°.

In addition, the latitude LAT of the place where the glass greenhouse 300 is installed is assumed to be north latitude 36.1°. In this case, the range of the sloping angle α obtained from the above-described (1) formula is

27.5°≦α≦33.5°. formula (12)

The sloping angle α=30.1° satisfies the formula (12).

Furthermore, the length L_{E} of the eave 313 of the sloping roof 322 of the southernmost greenhouse unit 311 is assumed to be 2.4 m. On the other hand, the length L_{I} of the eaves 313 of the sloping roofs 322 of the greenhouse units 311 is assumed to be 1.0 m.

In this case, the ranges for L_{E} and L_{I} obtained from above-described formulas (2) and (3) are

L_{E}≧1.24, formula (13)

and

L_{I}≧0.54, formula (14)

respectively. In this case, L_{E}=2.4 m and L_{I}=1.0 m satisfy these formula, respectively.

The sloping roofs 322 and the eaves 313 of the respective greenhouse units 311 are assumed to be formed of multilayered glazing having a heat reflective function (shielding factor is 0.42). In contrast, all the other surfaces of the respective greenhouse units 311 are assumed to be formed of single glass sheets (shielding factor is 0.89).

Under the above-described assumption, referring to the database of an hourly average amount of solar radiation in greater solar radiation years released from NEDO, an average amount of solar radiation entering the second glass greenhouse is calculated for each hour in each month.

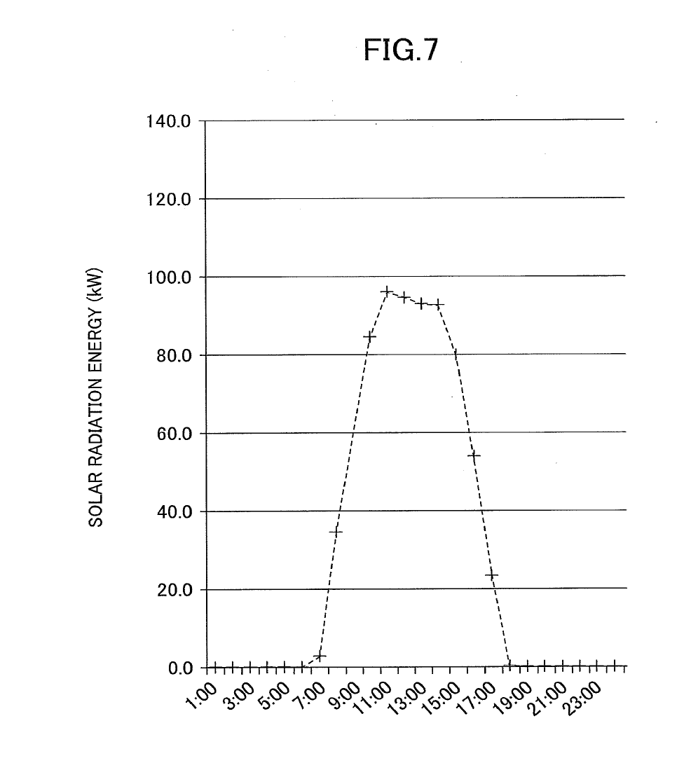

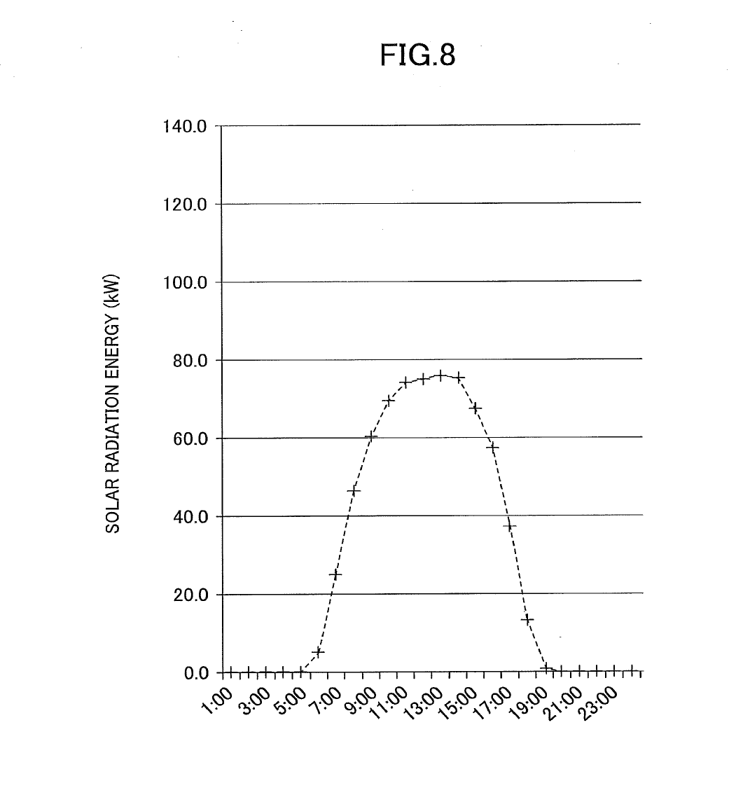

FIGS. 7 and 8 depict an example of the result of calculation.

In FIG. 7, time variation of the average amount of solar radiation in February is illustrated. Moreover, in FIG. 8, time variation of the average amount of solar radiation in August is illustrated. Ordinate axes of FIGS. 7 and 8 are illustrated in solar radiation energy rate (kW).

Comparing FIGS. 7 and 8, in the case of the second glass greenhouse 300, great difference in the average amount of solar radiation in daytime is not found between the cold season (February) and the hot season (August). Particularly, in the case of the second glass greenhouse 300, the average amount of solar radiation in the cold season (February) is somewhat greater than the average amount of solar radiation in the hot season (August). Therefore, greater amount of incident light is found to enter the second glass greenhouse 300 in the cold season (February).

Next, amounts of solar radiation for the respective time zones obtained in each month are integrated, to calculate average solar radiation energy per a day in each month. As a result, for example, the average solar radiation energy of February is 724 kWh, and the average solar radiation energy of August is 692 kWh.

### First Comparative Example

Next, in the conventional glass greenhouse 1, as depicted in above-described FIG. 1, the same calculation is performed.

Here, in the conventional glass greenhouse 1, the width in the north-south direction of each glass greenhouse 1 is assumed to be 3 m, and the width in the east-west direction is assumed to be 10 m. Moreover, the height of each greenhouse unit 11 (height up to the top portion) (height of block) is assumed to be 4.86 m. and the eave height is assumed to be 4.0 m.

The sloping angle of the roof 21 in each greenhouse unit 11 is assumed to be 30° in a counter clockwise direction with respect to the horizontal plane viewed from the bearing of east. The sloping angle of the roof 22 is assumed to be 30° in the clockwise direction with respect to the horizontal plane. In addition, the number of connected greenhouse units 11 is assumed to be five blocks.

Under the above-described assumption, the average amount of solar radiation entering the conventional glass greenhouse 1 is calculated for each time for each month using the same method as the first example.

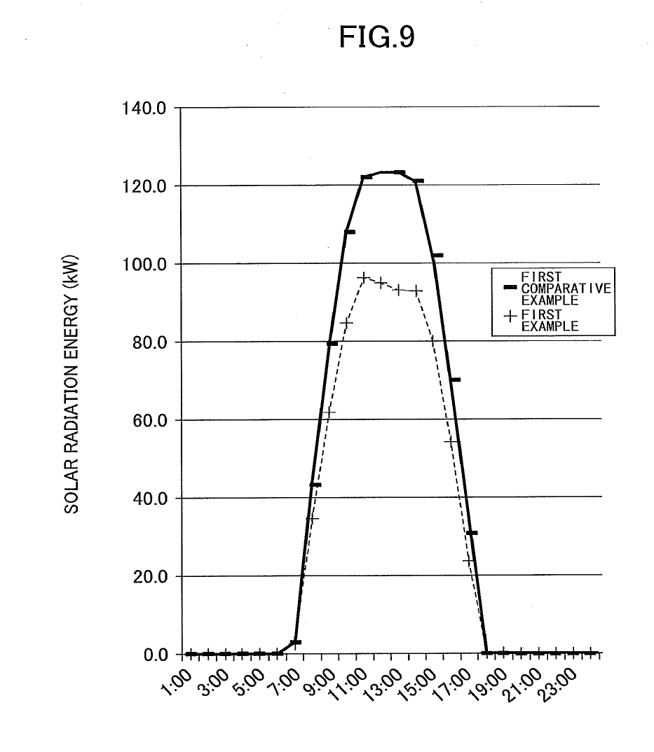

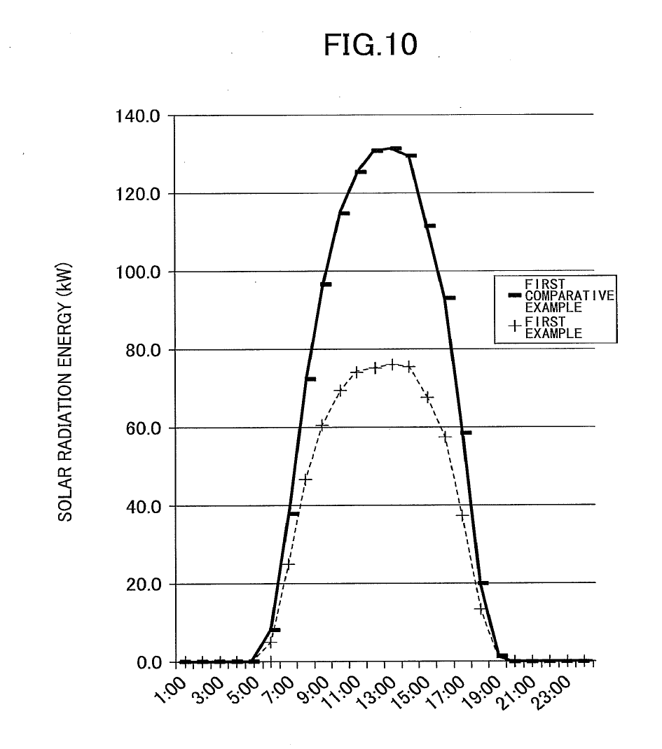

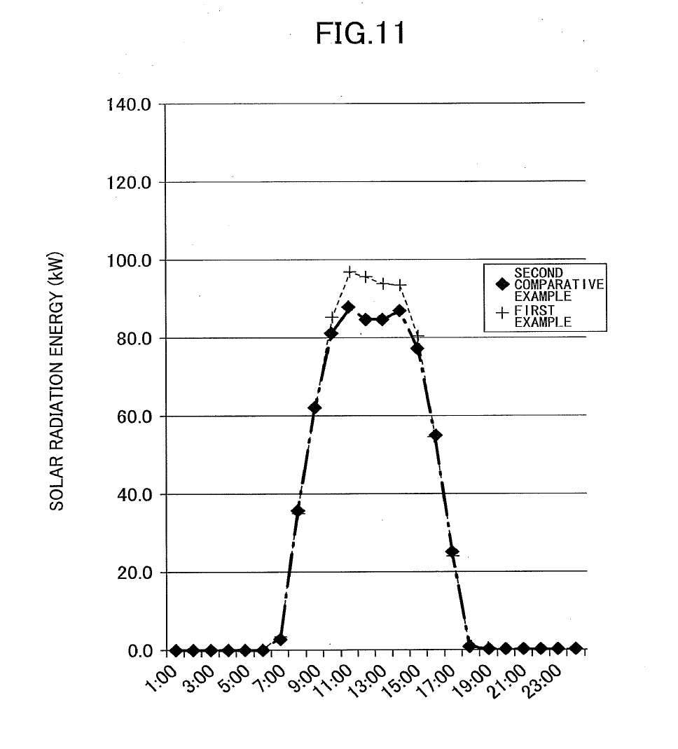

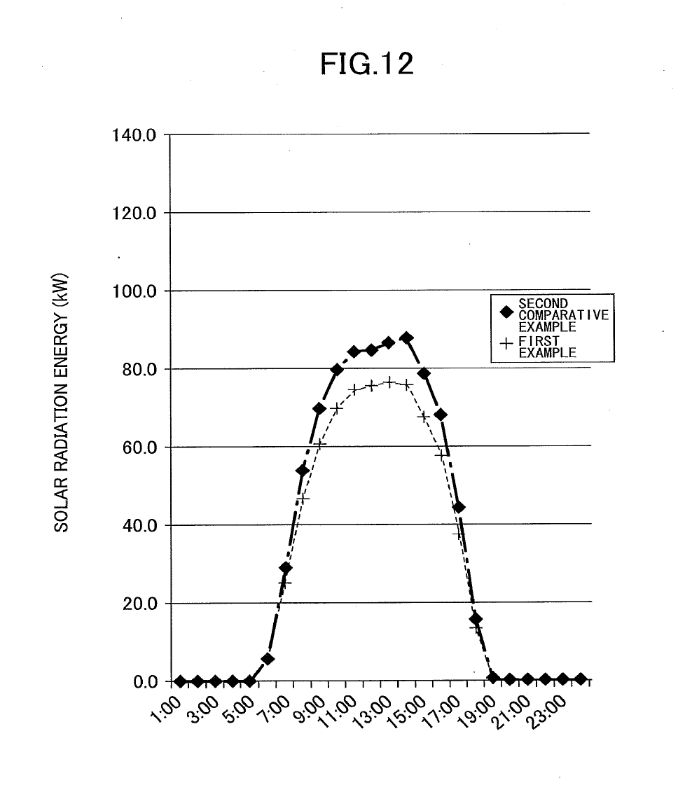

FIGS. 9 and 10 depict an example of the result of calculation. In FIG. 9, time variation of the average amount of solar radiation in February is illustrated. Moreover, in FIG. 10, time variation of the average amount of solar radiation in August is illustrated. Ordinate axes of FIGS. 9 and 10 are illustrated in solar radiation energy rate (kW). Moreover, in FIGS. 9 and 10, for reference, the results of calculation in the first example illustrated in FIGS. 7 and 8 are simultaneously shown.

Comparing FIGS. 9 and 10, in the case of the conventional glass greenhouse 1, the average amount of solar radiation in the hot season (August) is found to be greater than the cold season (February). Particularly, the average rate of solar radiation of daytime (around 12:00) in the hot season (August) exceeds 130 kW, and quite a great average amount of solar radiation is found to occur.

Next, amounts of solar radiation for the respective time zones obtained in each month are accumulated, to calculate average solar radiation energy per a day in each month. As a result, for example, the average solar radiation energy of February is 927 kWh, and the average solar radiation energy of August is 1132 kWh.

From the result, in the conventional glass greenhouse 1, difference in the amount of solar radiation is found to be great between the cold season (February) and the hot season (August). Moreover, particularly, in the hot season (August), considerable cooling by the temperature controlling equipment is found to be necessary.

In this way, in the solar light type glass greenhouse according to the example of the present invention, an amount of light entering the greenhouse is found to be able to be maintained within a predetermined range throughout the year. Moreover, according to this feature, a solar light type glass greenhouse that can be used throughout the year while suppressing operation cost is found to be able to be provided.

### INDUSTRIAL APPLICABILITY

The present invention can be used, for example, for a solar light type glass greenhouse or the like that can be applied to horticultural cultivation, a heated pool, or the like.

The present application is based on an claims the benefit of priority of Japanese Priority Application No. 2014-140933 filed on Jul. 8, 2014, the entire contents of which are hereby incorporated by reference.

### REFERENCE SIGNS LIST

1 Venlo-type glass greenhouse
2 north side
4 south side
6 east side
8 west side
11 greenhouse unit
12 top portion
20 ceiling part
21 roof
22 roof
50 under-eaves part
52 north lowersurface part
54 south lowersurface part
56 east lowersurface part
58 west lowersurface part
101 solar light
102 solar light
200 first glass greenhouse
202 north side
204 south side
206 east side
208 west side
212 outer end
213 eave
215 eave member
220 ceiling part
222 sloping roof
224 south uppersurface part
226 east uppersurface part
228 west uppersurface part
232 first ceiling glass member
234 second ceiling glass member
236 third ceiling glass member
238 fourth ceiling glass member
250 under-eaves part
252 north lowersurface part
254 south lowersurface part
256 east lowersurface part
258 west lowersurface part
262 first under-eaves glass member
264 second under-eaves glass member
266 third under-eaves glass member
268 fourth under-eaves glass member
300 second glass greenhouse
302 north side
304 south side
306 east side
308 west side
311 (311a to 311e) greenhouse unit
312a to 312e south end part
313a to 313e eave
320 (320a to 320e) ceiling part
322a to 322e sloping roof
324a to 324e south uppersurface part
326a to 326e east uppersurface part
328a to 328e west uppersurface part
332a to 332e first ceiling glass member
334a to 334a second ceiling glass member
336a to 336e third ceiling glass member
338a to 338e fourth ceiling glass member
350 (350a to 350e) under-eaves part
352a to 352e north lowersurface part
354a to 354e south lowersurface part
356a to 356e east lowersurface part
358a to 358e west lowersurface part
362a to 362e first under-eaves glass member
364a to 364e second under-eaves glass member
366a to 366e third under-eaves glass member
368a to 368e fourth under-eaves glass member

1. A solar light type glass greenhouse, comprising a greenhouse unit that includes an under-eaves part and a ceiling part,
wherein the under-eaves part includes a north lowersurface part, a south lowersurface part, an east lowersurface part, and a west lowersurface part,
wherein the ceiling part includes a sloping roof on a north side, a south uppersurface part on a south side, an east uppersurface part on an east side, and a west uppersurface part on a west side,
wherein the north side includes the north lowersurface part and the sloping roof, the south side includes the south lowersurface part and the south uppersurface part, the east side includes the east lowersurface part and the east uppersurface part, the west part includes the west lowersurface part and the west uppersurface part, and a sum of a vertical length of the south lowersurface part and a vertical length of the south uppersurface part is Hs,
wherein the sloping roof slopes by a sloping angle α so that a south side of the sloping roof is inclined upward from a horizontal plane when the solar light type glass greenhouse is viewed from east, α being greater than 15° but less than 67°,
wherein the sloping angle α is greater than or equal to 63.6°-LAT but less than or equal to 69.6°-LAT, where LAT is a latitude of an installation place at which the solar light type glass greenhouse is installed,
wherein the sloping roof includes an eave having a length L_{E} extending to south beyond the south uppersurface part,
wherein the length L_{E} of the eave is greater than or equal to H_{S}×sin(90°-θ_{S})/sin(θ_{S}-α), where θ_{S} is a culmination altitude of the sun in the summer solstice at the installation place,
wherein the south uppersurface part and the south lowersurface part include a glass member, and
wherein the sloping roof includes a glass member having a heat reflective function.

2. The solar light type glass greenhouse according to claim 1,
wherein the length L_{E} of the eave is less than 2×H_{S}×sin(90°-θ_{S})/sin(θ_{S}-α).

3. The solar light type glass greenhouse according to claim 1,
wherein the glass member having the heat reflective function is a multilayered glazing.

4. The solar light type glass greenhouse according to claim 1,
wherein the north lowersurface part includes a glass member.

5. The solar light type glass greenhouse according to claim 4,
wherein the glass member arranged on the north lowersurface part is a multilayered glazing.

6. The solar light type glass greenhouse according to claim 4,
wherein the glass member arranged on the north lowersurface part has a function of reflecting solar light toward inside of the solar light type glass greenhouse.

7. The solar light type glass greenhouse according to claim 1,
wherein at least one of the east uppersurface part and the west uppersurface part includes a glass member.

8. The solar light type glass greenhouse according to claim 7,
wherein the glass member arranged on at least one of the south uppersurface part and the south lowersurface part is a multilayered glazing.

9. A solar light type glass greenhouse, comprising a plurality of greenhouse units, which are arranged adjoiningly in a north-south direction, n being a number of the greenhouse units,
wherein each of the greenhouse units includes an under-eaves part and a ceiling part, the ceiling part including a sloping roof on a north side and a south uppersurface part on a south side, a vertical length of the south uppersurface part being H_{S1},
wherein the sloping roof of each of the greenhouse units slopes by a sloping angle α so that a south side of the sloping roof is inclined upward from a horizontal plane when the solar light type glass greenhouse is viewed from east, α being greater than 15° but less than 67°,
wherein the sloping angle α is greater than or equal to 63.6°-LAT but less than or equal to 69.6°-LAT, where LAT is a latitude of an installation place at which the solar light type glass greenhouse is installed,
wherein a southernmost greenhouse unit includes a south lowersurface part on the south side of the under-eaves part, a vertical length of the south lowersurface part being H_{S2}, and the sloping roof of the southernmost greenhouse unit includes an eave having a length L_{E} extending to south beyond the south uppersurface part,
wherein the length L_{E} of the eave of the southernmost greenhouse unit is greater than or equal to H_{S}×sin(90°-θ_{S})/sin(θ_{S}-α), where θ_{S} is a culmination altitude of the sun in the summer solstice at the installation place, and H_{S} is a sum of the vertical length H_{S1} of the south uppersurface part of the southernmost greenhouse unit and the vertical length θ_{S2} of the south lowersurface part,
wherein the sloping roofs of the greenhouse units other than the southernmost greenhouse unit include eaves having a length L_{I} extending to south beyond the south uppersurface parts, respectively,
wherein the length L_{I} of the eave is greater than or equal to H_{S1}×sin(90°-θ_{S})/sin(θ_{S}-α),
wherein the south uppersurface part of each of the greenhouse units includes a glass member,
wherein the south lowersurface part of the southernmost greenhouse unit includes a glass member, and
wherein the sloping roof of each of the greenhouse units includes a glass member having a heat reflective function.

10. The solar light type glass greenhouse according to claim 9,
wherein the length L_{E} of the eave is less than 2×H_{S}×sin(90°-θ_{S})/sin(θ_{S}-α).

11. The solar light type glass greenhouse according to claim 9,
wherein the length L_{I} of the eave is less than 2×H_{S1}×sin(90°-θ_{S})/sin(θ_{S}-α).

12. The solar light type glass greenhouse according to claim 9,
wherein at least one of the glass members having the heat reflective function is a multilayered glazing.

13. The solar light type glass greenhouse according to claim 9,
wherein a northernmost greenhouse unit includes a north lowersurface part on the north side of the under-eaves part, and the north lowersurface part includes a glass member.

14. The solar light type glass greenhouse according to claim 13,
wherein the glass member arranged on the north lowersurface part is a multilayered glazing.

15. The solar light type glass greenhouse according to claim 13,
wherein the glass member arranged on the north lowersurface part has a function of reflecting solar light toward inside of the solar light type glass greenhouse.

16. The solar light type glass greenhouse according to claim 9,
wherein the ceiling part of each of the greenhouse units includes an east uppersurface part on an east side and a west uppersurface part on a west side, and at least one of the east uppersurface part and the west uppersurface part includes a glass member.

17. The solar light type glass greenhouse according to claim 9,
wherein the glass member arranged on the south uppersurface part of each of the greenhouse units is a multilayered glazing.

18. The solar light type glass greenhouse according to claim 9,
wherein the glass member arranged on the south lowersurface part of the southernmost greenhouse unit is a multilayered glazing.

19. The solar light type glass greenhouse according to claim 9,
wherein a number of the greenhouse units n is greater than or equal to 2 but less than or equal to 30.
